(19) United States
(12) Patent Application Publication
(10) Pub. No.: US 2012/0027518 A1
(43) Pub. Date: Feb. 2, 2012

(54) Containment Boom

(75) Inventor: Donald Charles Van Houten, JR., Spring, TX (US)

(73) Assignee: GSE Lining Technology, Inc.

(21) Appl. No.: 12/910,961

(22) Filed: Oct. 25, 2010

Related U.S. Application Data
(60) Provisional application No. 61/369,831, filed on Aug. 2, 2010.

(51) Int. Cl. E02B 15/04; B23P 11/00

(52) U.S. Cl. 405/63; 29/428

(57) ABSTRACT

A containment boom for floating substances, including a long section of linear low density polyethylene folded over and heat sealed to form (i) a top sleeve along the length of the long section, (ii) a second sleeve along the length of the long section adjacent to and beneath the top sleeve, (iii) a bottom sleeve, and (iv) a skirt along the length of the long section extending downwardly from the second sleeve to the bottom sleeve. The second sleeve has a plurality of separate watertight pockets defined along its length by vertical seals extending between the top sleeve and the skirt. First and second rigid connectors extend from the top sleeve to the bottom sleeve at the longitudinal ends of the long section. Cables are in the top and bottom sleeves, with the cables at one end being secured to the first connector, and the cables at the other end being secured to the second connector. A plurality of closed cell foam segments are each tapered to a narrow edge at both longitudinal ends, and are disposed in each of the second sleeve pockets.

### CROSS-REFERENCE TO RELATED APPLICATIONS

This application claims priority in Provisional Application Ser. No. 61/369,831, filed Aug. 2, 2010, entitled “Oil Boom”, which is hereby incorporated by reference in its entirety.

### FEDERALLY SPONSORED RESEARCH OR DEVELOPMENT

Not Applicable.

### MICROFICHE/COPYRIGHT REFERENCE

Not Applicable.

### FIELD OF THE INVENTION

The present invention relates to booms, and more particularly to containment booms which may be advantageously used to surround and collect oil and other hazardous or non-hazardous floating substances.

### BACKGROUND OF THE INVENTION

Boom assemblies are used as barriers to contain or otherwise control materials buoyantly floating on a body of water. In the well known example of oil products spilled in a body of water, the booms may be used to contain the oil in an area of the body of water to facilitate removal of the oil products. In those circumstances, booms may also be used to direct the oil away from an area (to protect that area) and toward another area (where the oil may be accumulated to also facilitate removal). Of course, the amount of material as well as the area of disbursement of the material

It should be easily appreciated that it may be necessary to use containment booms in a wide variety of conditions. Of course, weather conditions may vary widely, from calm seas to heavy rolling seas in storms, and may vary by location, whether in open seas, near shore, and in shallow and deep areas. Moreover, it should be appreciated that different lengths of booms may be required depending on conditions, from a few hundred feet to thousands of feet.

Booms have heretofore been provided in a variety of designs.

For example, Cooper U.S. Pat. No. 5,522,674 discloses a boom which is formed with a long sheet of material, such as a fabric sealed with a coating of polyvinylchloride, folded over and heat sealed to form an upper pocket, flotation chambers beneath the upper pocket, a skirt extending downwardly from the flotation chambers, and a bottom pocket. A tension cable is located in the upper pocket, a chain functions as ballast in the bottom pocket, and a flotation sub-assembly is in the flotation chambers. The flotation subassembly includes open cell flotation members which may be deflated (by forcing the air out) for storage on a reel, with the boom assembled by wrapping a long edge of the material around the flotation sub-assembly. The ends of the boom include a connector which may be connected to the mating interlocking flanges of the connector on the ends of an adjacent boom.

As another example, Ware U.S. Pat. No. 5,580,185 discloses a boom formed from a fabric which is also folded over and variously heat sealed to define channels along the top and bottom, each enclosing polyethylene tubing which enclose polyester webbings. A spiral wound air bubble material is in a heat sealed compartment beneath the top channel, and a skirt depends down from the air bubble compartment with ballasts of sand sealed in a polyester tubing at the bottom of the skirt (and above the bottom tubing.

As yet another example, Wong et al. U.S. Pat. No. 7,056,059 discloses a boom system having a generally similar boom structure, with box shaped floats formed of foam blocks wrapped in fabric.

Still other boom assemblies are disclosed in Goans et al. U.S. Pat. No. 5,346,329, Gunderson, III U.S. Pat. No. 5,102,261, Separovich U.S. Pat. No. 5,071,286, Taricco U.S. Pat. No. 5,040,918, Simpson U.S. Pat. No. 4,537,528, Blair U.S. Pat. No. 4,295,756, Langermann U.S. Pat. No. 4,188,155, Preus U.S. Pat. No. 4,124,981, West U.S. Pat. No. 4,030,304, Larsson U.S. Pat. No. 3,757,526, Smith U.S. Pat. No. 3,499,290, and British Patent No. 1,345,369.

Unfortunately, prior art booms have presented one or more of a variety of problems.

For example, the flexibility along the length of the booms may be suitable when in the water in use, but the stiffness along the length when taken out of the water may make the boom difficult to handle and store. Special structures used to address handling and storage difficulties, such as the deflatable flotation chambers in the Cooper '674 patent, can add their own difficulties (e.g., requiring manipulation of valves and/or caps over the valves along the length of the boom to allow deflation when removing from the water and inflation when deploying in the water).

As another example, booms which are sufficiently flexible when being handled may be too flexible when deployed (e.g., the skirt portion below the water line may be too easily moved out of its vertical orientation by currents or other forces and allow the material intended to be contained to pass underneath and past the boom.

Further, initial manufacture of prior art booms may be unnecessarily time consuming and/or costly, and/or may not allow for easy manufacturing of a durable and reliable boom.

As yet another example, the ends of prior art booms typically have connectors which are relatively heavy and at the same time require a discontinuance at that location of the buoyant portion of the boom, with the result being that the barrier intended by the boom at that location may be dragged down sufficiently low in the water that the material being contained may be able to splash or wash over the top and escape the boom.

The present invention is directed toward overcoming one or more of the above problems.

### SUMMARY OF THE INVENTION

In one aspect of the present invention, a containment boom is provided for surrounding and collecting floating substances, including a long section of linear low density polyethylene folded over and heat sealed to form (i) a top sleeve along the length of the long section, (ii) a second sleeve along the length of the long section adjacent to and beneath the top sleeve, (iii) a bottom sleeve, and (iv) a skirt along the length of the long section extending downwardly from the second sleeve to the bottom sleeve. The second sleeve has a plurality of separate watertight pockets defined along its length by vertical seals extending between the top sleeve and the skirt. First and second rigid connectors extend from the top sleeve to the bottom sleeve at the longitudinal ends of the long section, with the connectors adapted to connect adjacent booms together. Cables are in the top and bottom sleeves, with the cables at one end being secured to the first connector, and the cables at the other end being secured to the second connector. A plurality of closed cell foam segments are each tapered to a narrow edge at both longitudinal ends, and are disposed in each of the second sleeve pockets.

In one aspect of the present invention, the foam segment tapers are wedge shaped and oriented with a substantially vertical narrow edge.

In another aspect of the present invention, the seals are heat sealed. In a further form, the seals are heat welded.

In still another aspect of the present invention, cable in the top sleeve is sheathed in polyethylene tubing.

In yet another aspect of the present invention, the foam segments have a length 10 to 12 times their diameter. In a further form, the foam segments are substantially six inches in diameter and in a still further form, the pockets are longer than the foam segments by a length about equal to the diameter of the foam segments.

In another aspect of the present invention, a method of making a containment boom for surrounding and collecting floating substances is provided, including the steps of: (a) providing a long section of linear low density polyethylene; (b) placing a bottom cable adjacent one longitudinal side of the long section; (c) folding one longitudinal side of the long section over the bottom cable and sealing the edge of the longitudinal side to define a bottom sleeve with the bottom cable therein; (d) placing a longitudinally extending top cable on the long section; (e) folding the other longitudinal side of the long section over the top cable and sealing an intermediate location to define a top sleeve with the top cable therein; (f) sealing the edge of the other longitudinal side of the long section to define a third longitudinally extending sleeve adjacent the top sleeve; (g) sealing across the height of the third sleeve at an intermediate longitudinal location; (h) from both ends of the third sleeve, pushing a closed cell foam segment into the third sleeve to a location adjacent the intermediate seal; (i) sealing across the height of the third sleeve behind each foam segment to define watertight pockets in which the foam segments are trapped; (j) repeating steps (h) and (i) until the third sleeve is substantially fully defined by watertight pockets with foam segments; (k) securing connectors to the ends of the long section along substantially the entire height from the bottom sleeve to the top sleeve; and (l) securing the ends of the cables to the connectors.

In a further form of this aspect of the invention, the foam segments are each tapered to a narrow edge at both longitudinal ends.

Other objects, features, and advantages of the invention will become apparent from a review of the entire specification, including the appended claims and drawings.

### BRIEF DESCRIPTION OF THE DRAWINGS

FIG. 1 is a broken away perspective view of the ends of two booms according to the present invention, attached together on their ends;

FIG. 2 is a perspective view of one end of the oil boom of FIG. 1, with portions broken away and cut in cross-section;

FIG. 3 is a front view of the oil boom end of FIG. 2;

FIG. 4 is a perspective view of an oil boom according to the present invention, laid out generally horizontally;

FIG. 5 is a perspective view of a body of water with an oil boom according to the present invention there; and

FIG. 6 is a top view illustrating the manufacture of an oil boom according to the present invention.

### DETAILED DESCRIPTION OF THE PREFERRED EMBODIMENT

A containment boom 10 according to the present invention is illustrated in the Figures and described here. The containment boom 10 may be used to advantageously surround and collect oil or other hazardous or non-hazardous floating substances.

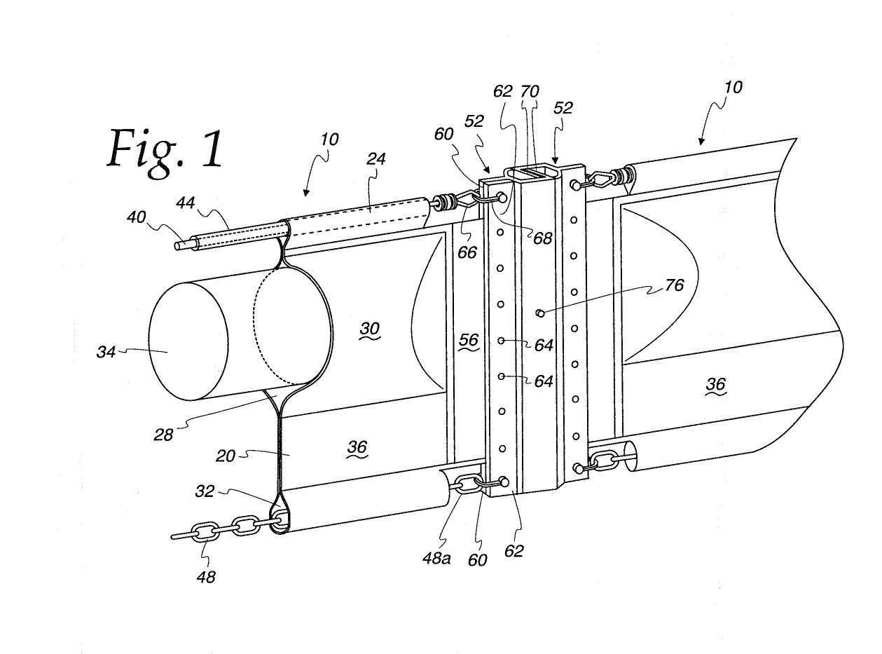

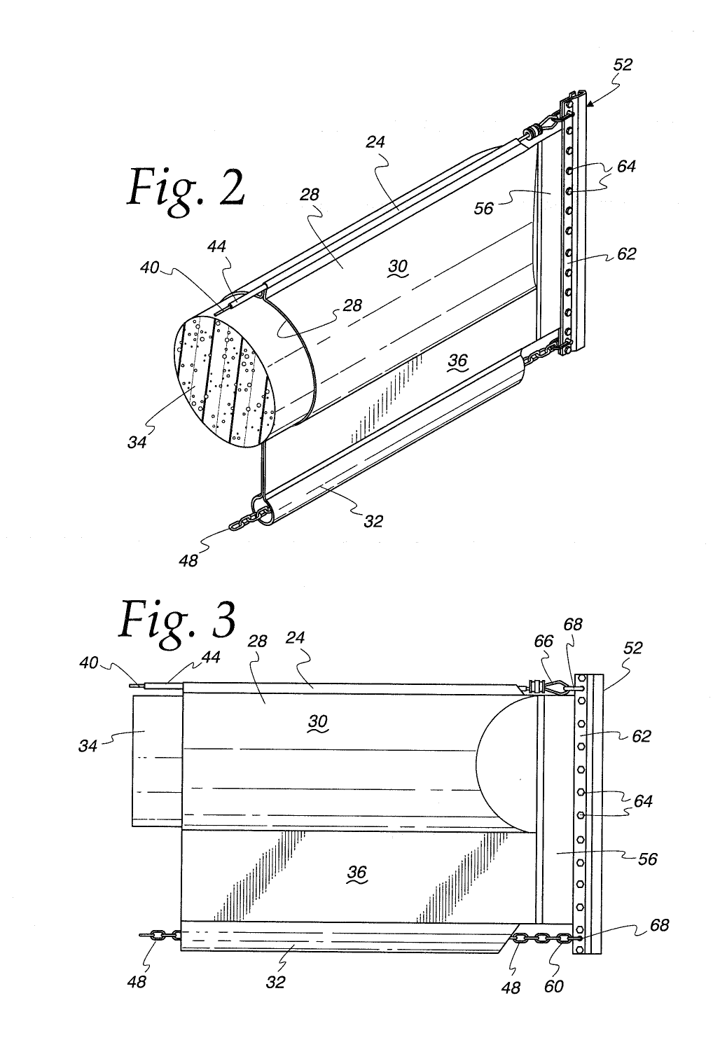

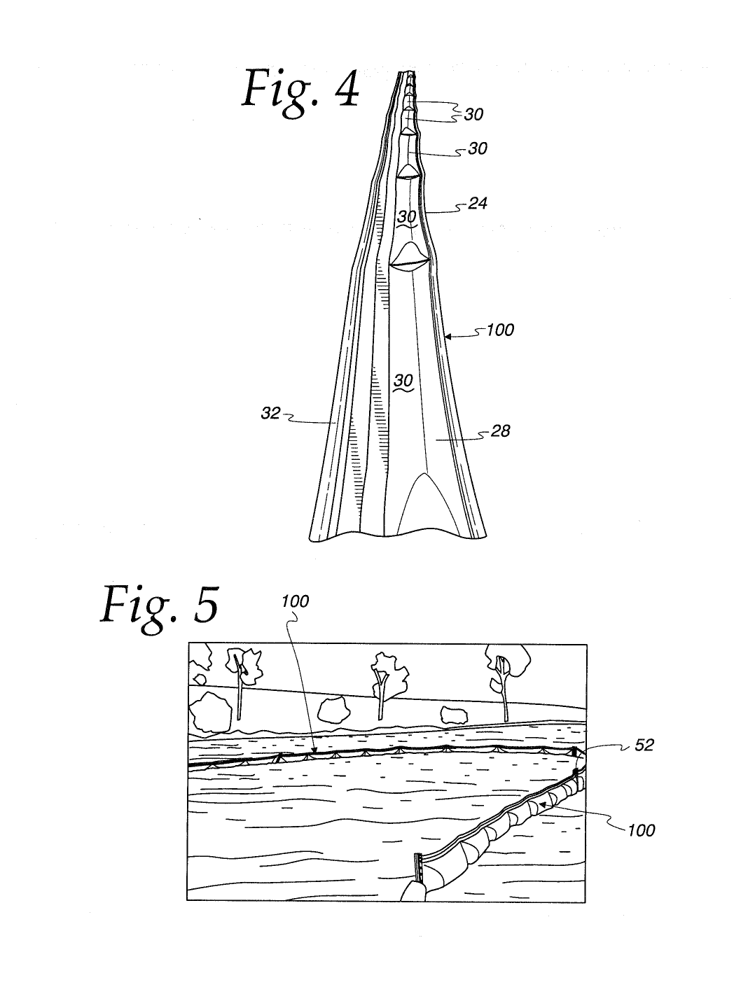

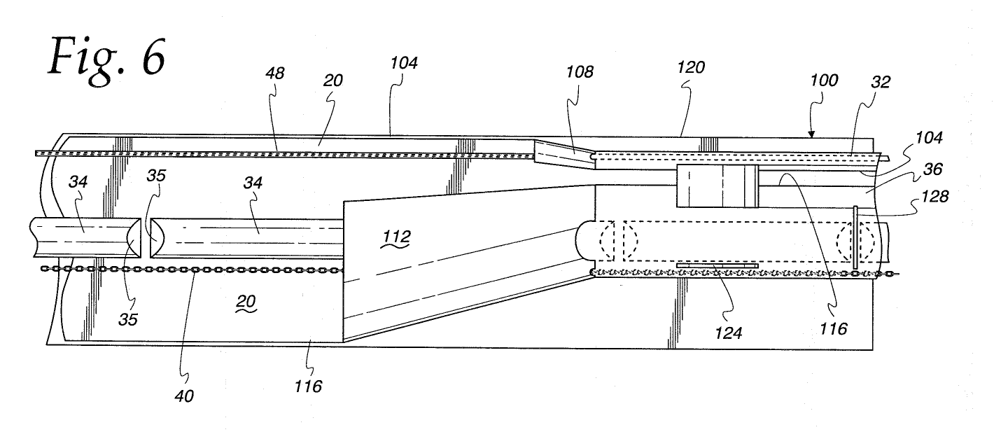

As illustrated particularly in FIGS. 1-3, the oil boom 10 advantageously consists of a long section of linear low density polyethylene (LLDPE) “fabric” 20 (e.g., 20 MIL) folded over and sealed (see FIG. 6, described hereafter) to form a top sleeve 24, a second sleeve 28 beneath the top sleeve 24, and a bottom sleeve 32. The LLDPE fabric 20 may be formed of a single sheet of material, which material may be in a suitable color for the environment in which the boom 10 is expected to be used. For example, yellow may be advantageous in open water when trapping oil to ensure that the boom may be easily seen.

As described in greater detail hereafter, the second sleeve 28 is formed into separate watertight pockets 30 defined along its length (e.g., by vertical seals spaced along the length of the boom 10), with each pocket 30 including a closed cell foam segment 34 having tapered ends 35 (see particularly FIG. 6). The foam segments 34 may be relatively short with a length of ten to twelve times their diameter (e.g., 63 inches in length and about six inches in diameter).

Advantageously, each set of pockets 30 is welded or otherwise securely sealed (described further below) to ensure that there is an airtight/watertight seal between each segment 34. This traps air which helps the buoyancy but also protects the boom 10 from filling with water if one section is damaged.

Further, the tapered ends 35 of the foam segments 34 are advantageously wedge shaped and oriented with the tapered narrow edge substantially vertical (i.e., generally extending from top to bottom, which corresponds to the vertical orientation of the boom 10 when used). The pockets 30 in the second sleeve may be, for example, longer than the foam segments 34 by a length about equal to the diameter of the foam segments 34.

It should be appreciated that the short length and tapered ends 35 of the foam segments 34 may advantageously facilitate handling of the long boom 10 (e.g., when transporting or handling) by enabling easy bending of the boom 10. Moreover, it should also be appreciated that the tapered ends 35 of the foam segments 34 allow the foam segments 34 to extend near to the end of each pocket 30, thereby providing only minimal spacing between adjacent foam segments 34. That is, the foam segments 34 may be tapered so that they may readily extend to within approximately 3″ to 4″ of the seam between pockets 30, giving the boom 10 more buoyant material per linear foot of boom 10. This provides the desired buoyancy along most all of the length of the boom 10 and minimizes gaps between foam segments 34, thereby ensuring sufficient buoyancy along the entire length and avoiding portions where the top of the boom 10 could otherwise sink undesirably low in the water (particularly at the ends of the boom 10 where the relatively heavy connectors [described hereafter] are located).

A skirt 36 along the length of the long boom 10 extends downwardly from the second sleeve 28 to the bottom sleeve 32, and may be made of varying heights (e.g., 18, 24 and 36 inches) to allow for different depth extensions of the boom 10 into the water.

A suitable cable 40 (e.g., advantageously a 5/16 inch diameter galvanized aircraft cable) extends along the length of the boom 10. The cable 40 may be advantageously protected inside a polyethylene tubing 44, with both the cable 40 and tubing 44 extending through the top sleeve 24 from one end to the other of the boom 10. The cable 40 provides strength against the skirt top tearing or stretching unacceptably, and also provides not only flexibility to allow the boom 10 to flex but also rigidity to help maintain the boom 10 in a generally longitudinal orientation (without too much accordion or serpentine folding when in the water).

A chain 48 (e.g., advantageously a 5/16 or ⅜ inch diameter galvanized aircraft chain) extends along the length of the boom 10 inside the bottom sleeve 32. The chain 48 not only serves as ballast to ensure that the skirt 36 extends down when placed in water, but also provides strength against the skirt bottom tearing or stretching unacceptably, while also providing that the skirt 36 may also bunch up to a slightly shorter length given the nature of chain links.

At each end of the boom 10, a suitable rigid connector 52 is provided to enable multiple booms 10 to be connected together end to end, thereby allowing for use of virtually limitless lengths of booms 10 by attaching multiple booms 10 together (see, e.g., FIG. 5), even though individual booms 10 may be, for example, 100 feet in length. Advantageously, the connectors 52 may be interchangeable, such as an ASTM universal slide connector, to allow booms of any design to be connected together.

Each connector 52 may advantageously clamp a flattened end 56 of the folded over polyethylene fabric 20 (e.g., along the height between the top and bottom sleeves 24, 32) between facing plates 60, 62 of the connector 52, with stainless bolts 64 (e.g., with Nylock lock nuts) extending through the plates 60, 62 and the flattened end 56 at locations spaced along their height.

The cable 40 is suitably secured to the connector 52, as is the chain 48, for example by a looped cable end 66 or chain link 48a connected to suitable brackets 68 at the top and bottom of the connector 52. A zinc plated shackle and thimble, for example, and aluminum swaging of the cable 40 may also be advantageously used.

Each connector 52 is suitably configured to allow for easy and secure connecting and disconnecting of adjacent booms 10. For example, mating connectors 52 may slide together vertically to provide overlapping legs 70 which interfere with the booms 10 being pulled apart horizontally in the direction of their lengths. Such vertical connections may be free floating, although holes 76 may be provided, for example, for toggle bolts, to hold the connectors 52 of adjacent booms 10 together.

It should be appreciated that the use of LLDPE is particularly advantageous with this configuration. LLDPE provides some flexibility, as is needed to package the boom 10 when not in use, it being difficult to handle and transport the boom 10 unless shortened from its long orientation (e.g., 100 feet). Moreover, while providing needed flexibility, LLDPE will also provide the stiffness required to enable the boom 10 to support the relatively heavy connectors at the boom ends, to thereby keep the boom 10 floating high in the water and thereby additionally preventing what could otherwise be low points in the intended barrier of the boom 10 where oil or other material could migrate or pass over and past the booms 10 (especially in rough waters). Further, LLDPE is advantageously resistant to UV and chemical damage, as well as being easy to clean and decontaminate.

As noted, the booms of the present invention may be formed in a variety of sizes, in addition to lengths, for example, with different foam diameters and/or different skirt heights. For example, an 18″ size boom having a 100 foot length may be formed with the following materials:

| Materials | Quantity | |
|---|---|---|
| 20 Mil LLDPE Yellow | 500 | square feet |
| 25″ End connectors | 2 | each |
| Polyethylene tubing | 100 | linear feet |
| 5/16″ dia. galvanized aircraft cable | 100 | linear feet |
| 5/16″ dia. galvanized aircraft chain | 100 | linear feet |
| 5/16″ × 2″ Aluminum Swage | 2 | each |
| 5/16″ galvanized thimble | 2 | each |
| 5/16″ galvanized shackle | 6 | each |
| ⅜″ × 1″ stainless steel hex head bolt | 13 | each |
| ⅜″ stainless steel hex nuts with nylon lock washer | 13 | each |
| ⅜″ stainless steel washers | 26 | each |
| 6″ diameter foam × 63″ long foam | 16 | each |
| 0.5″ brass grommet | 1 | each |

Larger or smaller sizes (e.g., 24″ and 36″) could be manufactured with comparable materials, with correspondingly more or less materials.

Manufacture and construction of the boom 10 is particularly illustrated in FIG. 6, where a portion of the materials being assembled can be seen, for example, on a conveyor or work table 100 for illustration purposes.

The LLDPE fabric 20 initially consists of a long, flat material, for example 100 feet long and 5 feet wide. Along one edge 104 (the bottom edge), a suitable folding guide 108 may be used to fold over that side to overlap and form the bottom sleeve 32, for example, over the chain 48.

A similar, but larger folding guide 112 may also be provided at the other (top) edge 116 to fold over that side to overlap and for the top and second sleeves 24, 28, for example, over the cable 40 and foam segments 34.

Suitable sealing devices 120, 124, 128 may be provided to provide desired bonding or sealing (e.g., by heat sealing, such as heat welding) of the overlapped fabric 20. As illustrated, sealing device 120 may seal along the length of the boom 10 to close the top of the bottom sleeve 32 and the bottom of the second sleeve 28, sealing device 124 may seal along the length of the boom 10 to seal between the top sleeve 24 and second sleeve 28, and sealing device 128 may seal periodically along the height of the second sleeve 28 to form the separate pockets 30. It should be appreciated that the sealing devices 120, 124, 128 may be, for example, impulse welding machines and, moreover, are simply illustrated are exemplary devices. Still other sealing devices and manufacturing configurations could readily be used to manufacture booms 10 according to the present invention. For example, manufacture may be accomplished without using a sealing device 128 to separate the pockets 30 during initial assembly. Rather, the boom 10 may be advantageously formed by, for example, forming the sleeves (particularly the second sleeve 28) along the entire (100 foot) length of the boom 10, and then forming a suitable closure (as by impulse welding) near the middle of the sleeve 28. The foam segments 34 may thereafter be pushed into the sleeve 28 from both ends up to the middle weld, and another weld can be formed at the other end of each foam segment to form pockets 30 trapping those segments 34 in that central area, with the process repeated with further foam segments 34 along the entire length of the boom 10. Some persons skilled in the art have suggested that foam segments should extend to within 3 to 4 inches of the pocket ends. For example, sixteen pockets 30 may be formed along the length of a 100 foot boom with a 63 inch foam segment trapped in each of the pockets 30.

With an understanding of the invention as disclosed herein, it should be appreciated that booms 10 according to the present invention may be reliably and easily manufactured. Further, booms 10 made according to the present invention may be reliably and easily handled, whether when storing the booms 10 when not in use, transporting the booms 10 over the road, placing the booms 10 in water for use, or removing them from water. Still further, booms 10 made according to the present invention will function reliably in use, with sufficient buoyancy along their length, and at their connection to adjacent booms 10, to ensure that portions do not sink low into the water so as to potentially allow the material being blocked and/or collected to migrate past the boom 10.

1. A containment boom for surrounding and collecting floating substances, comprising:
a long section of linear low density polyethylene folded over and heat
sealed to form:
a top sleeve along the length of the long section,
a second sleeve along the length of the long section adjacent to and beneath the top sleeve,
a bottom sleeve, and
a skirt along the length of the long section extending downwardly from the second sleeve to the bottom sleeve,
wherein said second sleeve comprises a plurality of separate watertight pockets defined along its length by vertical seals extending between said top sleeve and said skirt;
first and second rigid connectors extending from the top sleeve to the bottom sleeve at the longitudinal ends of the long section, said connectors adapted to connect adjacent booms together;
cables in the top and bottom sleeves, said cables at one end being secured to said first connector, and said cables at the other end being secured to said second connector;
a plurality of closed cell foam segments, said foam segments being: each tapered to a narrow edge at both longitudinal ends, and disposed in each of said second sleeve pockets.

2. The containment boom of claim 1, wherein said foam segment tapers are wedge shaped and oriented with a substantially vertical narrow edge.

3. The containment boom of claim 1, wherein said seals are heat sealed.

4. The containment boom of claim 3, wherein said seals are heat welded.

5. The containment boom of claim 1, wherein the cable in the top sleeve is sheathed in a polyethylene tubing.

6. The containment boom of claim 1, wherein the foam segments have a length 10 to 12 times their diameter.

7. The containment boom of claim 6, wherein the foam segments are substantially six inches in diameter.

8. The containment boom of claim 7, wherein the pockets are longer than the foam segments by a length about equal to the diameter of the foam segments.

9. A method of making a containment boom for surrounding and collecting floating substances, comprising the steps of:
(a) providing a long section of linear low density polyethylene;
(b) placing a bottom cable adjacent one longitudinal side of the long section;
(c) folding one longitudinal side of the long section over the bottom cable and sealing the edge of the longitudinal side to define a bottom sleeve with the bottom cable therein;
(d) placing a longitudinally extending top cable on said long section;
(e) folding the other longitudinal side of the long section over the top cable and sealing an intermediate location to define a top sleeve with the top cable therein;
(f) sealing the edge of the other longitudinal side of the long section to define a third longitudinally extending sleeve adjacent the top sleeve;
(g) sealing across the height of the third sleeve at an intermediate longitudinal location;
(h) from both ends of the third sleeve, pushing a closed cell foam segment into the third sleeve to a location adjacent the intermediate seal;
(i) sealing across the height of the third sleeve behind each foam segment to define watertight pockets in which the foam segments are trapped;
(j) repeating steps (h) and (i) until the third sleeve is substantially fully defined by watertight pockets with foam segments;
(k) securing connectors to the ends of the long section along substantially the entire height from the bottom sleeve to the top sleeve; and
(l) securing the ends of the cables to the connectors.

10. The method of claim 9, wherein said foam segments are each tapered to a narrow edge at both longitudinal ends.
